(19) United States
(12) Patent Application Publication
(10) Pub. No.: US 2022/0398658 A1
(43) Pub. Date: Dec. 15, 2022

(54) System and method for lowering mortgage payments associated with a mortgage loan

(71) Applicants: Eric Iseley, South Glastonbury, CT (US); Andrew May, Raleigh, NC (US)

(72) Inventors: Eric Iseley, South Glastonbury, CT (US); Andrew May, Raleigh, NC (US)

(21) Appl. No.: 17/346,340

(22) Filed: Jun. 14, 2021

(51) Int. Cl. G06Q 40/02; G06Q 40/04

(52) U.S. Cl. CPC G06Q 40/025; G06Q 40/04

(57) ABSTRACT

In the present invention, a system and method is described for lowering costs associated with taxes, insurance and HOA payments, during the initial five and/or ten year periods of owning a home, by financing these costs and other ongoing charges related to the consummation of a mortgage loan. In addition to the cost savings, the consumer may set up an asset that helps generate additional income to the consumer. Cost savings are achieved and secondary market ownership of the mortgage results in a lower overall risk to the investor through the creation of an asset that may be accessed to offset costs of homeownership or mitigate risk to the investor in the mortgage.

### REFERENCES CITED [REFERENCED BY]

### U.S. Patent Documents

| | | |
|---|---|---|
| 8,527,402 | September 2013 | McDonald, et al. |
| 8,660,939 | February 2014 | Allen, et al. |
| 8,788,392 | July 2014 | Frank |
| 8,799,155 | August 2014 | Sheehy, et al. |
| 8,990,254 | March 2015 | Corr, et al. |
| 20160140654 | May 2016 | Bhat; Rajesh Pervaje; |
| | | et al. |
| 10,037,350 | July 2018 | Seal, et al. |
| 10,943,293 | March 2021 | Englehart, et al. |
| 10,949,919 | March 2021 | Tarmann, et al. |

Parent Case Text

### RELATED APPLICATION

This application is based upon the provisional application Ser. No. 60/249,422, entitled “SYSTEM AND METHOD FOR LOWERING MORTGAGE COSTS ASSOCIATED WITH A MORTGAGE LOAN,” filed on Jun. 14, 2021 for Eric Iseley and Andrew Walter May. The contents of this provisional application are fully incorporated herein by reference.

### FIELD OF SEARCH

### Description

### Field of the Invention

The present invention relates to a system and method for computing the mortgage interest rate and LTV to expand a mortgage loan size thus creating an asset that is intended to pay for the ‘costs of housing’, including but not limited to taxes, insurance, homeowners association dues, heating and air systems, and roofing.

### Background of the Invention

A mortgage, secured by the purchased real estate, allows the consumer to deliver the required purchase price to the seller. Typically, a consumer will put a down payment on the purchase of a home. With the invention, the consumer increases the indebtedness to lower the required down payment, causing the LTV to increase. In doing so, the consumer is able to keep more of the consumer's money by either creating an asset intended to pay for the consumer's ‘costs of housing’ listed above or keep the less required down payment as liquid assets.

For example, a consumer purchases a home for $200,000, intending to put a down payment of $100,000. With the invention, the consumer can put down 20% ($40,000) with the remaining $60,000 being used to create an asset, such as an insurance product, that would provide flexibility to the consumer. This flexibility enables the consumer to increase the assets' value over time or use the assets as a source of payment for ‘costs of housing.’ When the consumer sells the property, the asset remains with the consumer, providing the consumer with the appreciation in the home and the asset.

The consumer with the invention is substantially advantaged over the consumer without the invention because the asset created with the invention significantly decreases the probability of a mortgage default.

FIG. 1 is a flow chart summarizing a conventional mortgage compared with the same mortgage with the invention, ceteris paribus. The highest risk of a mortgage default comes from consumers with a job loss. In the case that a job loss occurs, the consumer that used the invention can pay for the ‘cost of housing’ through the invention's created asset. Without the invention, the consumer will either need to seek additional financial sources or trigger a mortgage default.

Licensed mortgage brokers along with some licensed mortgage lenders can calculate the LTV that would best meet the consumers' expected needs. For example, two 80% LTV consumers with identical financial profiles will have different probabilities of default because the consumer with the invention has a $60,000 asset to offset unexpected costs.

### SUMMARY OF THE INVENTION

The present invention is directed to a method for reducing mortgage costs associated with a mortgage loan. The initial increase in debt, which is amortized over 30 years, is offset by an asset that is intended to pay for the ‘costs of housing’ over a period of time. The consumer's highest risk of default occurs from year 3 to year 10. The invention provides more stability to consumers during the riskier period of default because the invention matches an asset for the consumer that pays for the ‘costs of housing.’ Scenario analyses have indicated that the invention may reduce claim rates in years 3-10 by as much as 10%, providing a significant savings to investors of the real estate financing industry. Some or all of the steps in the inventive method may be performed by a computerized system.

The invention enables the consumer to build an asset that provides a method of wealth growth outside of home price appreciation and/or funds to handle the ‘costs of housing,’ thereby lowering the probability of default through diversification during the peak claim period of years 3 through 10. Also, the invention enables the consumer to limit the required amount of cash to close a lower LTV loan. If the consumer is able to take advantage of the higher interest write-off and/or deferred asset growth, the consumer is again advantaged.

Investors will eventually gravitate toward the invention and likely offer interest rates that attract this high-quality type of consumer. Lenders, investors and mortgage guaranty companies will compete to attract these consumers in order to take advantage of the lower default rate these consumer pose on the mortgage finance system.

Such objects and advantages listed above are merely illustrative and not exhaustive. Furthermore, these and other features and advantages of the present invention will become more apparent from the accompanying drawings and the following detailed description.

### BRIEF DESCRIPTION OF THE DRAWINGS

The following detailed description, given by way of example and not intended to limit the present invention solely thereto, will best be understood in conjunction with the accompanying drawings in which:

FIG. 1 schematically illustrates a conventional mortgage finance system;

FIG. 2 is a flow chart that illustrates one embodiment of the Reduction in the Cost of Housing, in accordance with the present invention;

FIG. 3 schematically illustrates the method for reducing the Cost of Housing associated with a mortgage loan, in accordance with the present invention;

FIG. 4 is a three step chart illustrating a borrower's savings using the process of FIG. 2, in accordance with the present invention; and

FIG. 5 schematically illustrates a computer system used to calculate the borrower's asset growth and Cost of Housing payments according to the process of FIG. 2, in accordance with the present invention.

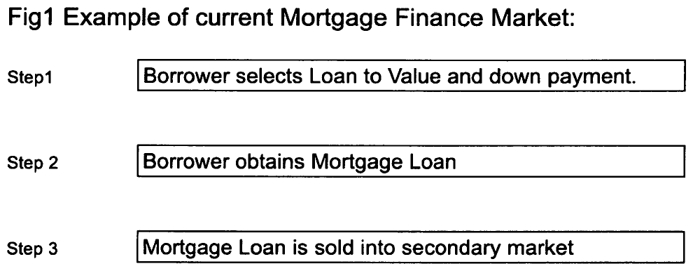

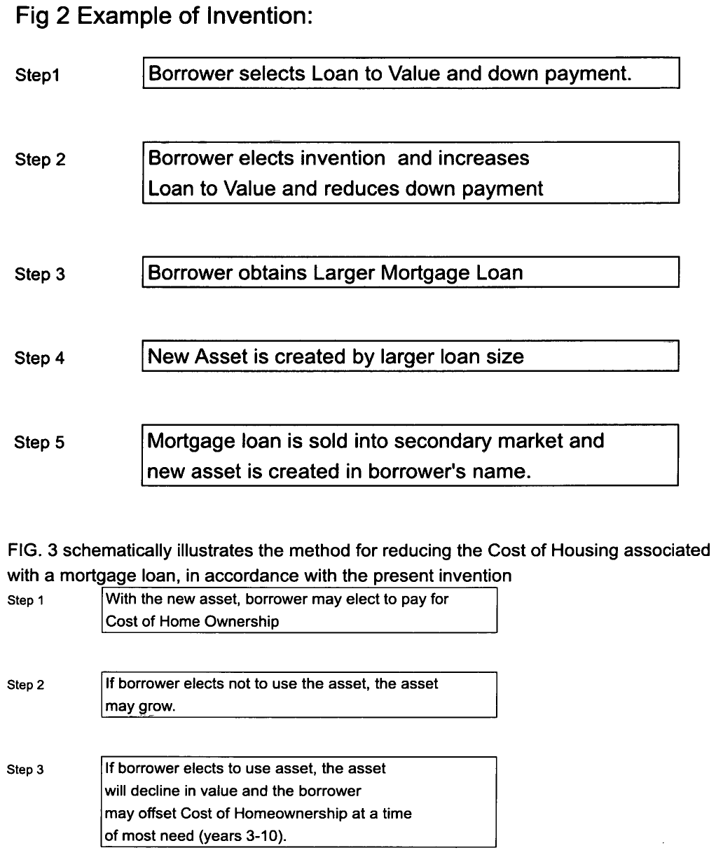

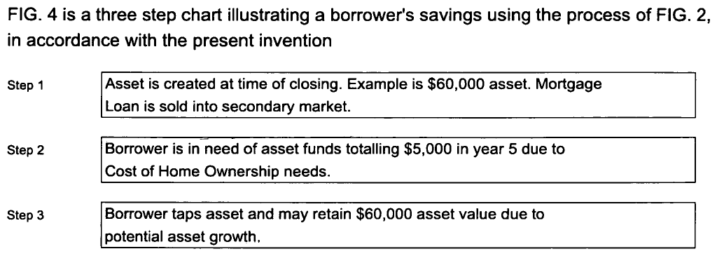

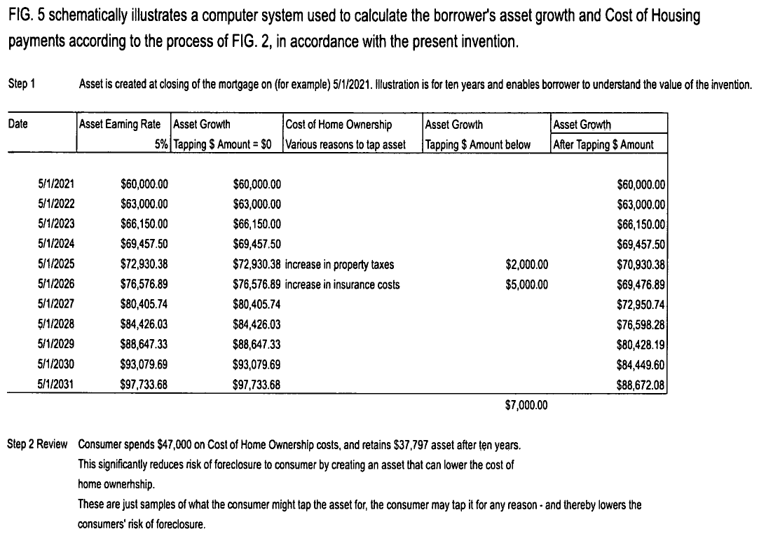

With the system and method for lowering mortgage costs associated with a mortgage loan created by the invention, the increase in debt may be financed over the life of the loan (e.g., 30 years); and, as stated above, the lender (and ultimately the borrower) is charged a mortgage interest rate. The 30-year amortization decreases the borrower's payments, while at the same time allowing the lender to get paid in fees up-front out of the mortgage proceeds, as well as the borrower's establishment of a new asset. In addition, the asset may serve to lower prepayment speeds of a mortgage as the consumer will enjoy the benefits of the asset's growth.

Finally, it should be understood that the foregoing description is merely illustrative of the invention. Numerous alternative embodiments within the scope of the appended claims will be apparent to those of ordinary skill in the art.

What is claimed:

1. A method for reducing mortgage costs associated with a financial product, comprising the steps of: determining an original loan-to-value (LTV) ratio of a financial product, said financial product having an amount and an interest rate associated therewith, wherein said financial product necessitates a purchase of a mortgage loan and/or insurance product for said financial product when said original loan is increased to a higher loan balance in order to establish a new asset. The gross LTV (loan-to-value) is increased in order to establish the new asset. Said asset is established to either pay taxes and homeowners insurance and/or other housing related costs such as repairs, replacement, HOA, and other housing costs; achieving a gross LTV ratio that is increased from said original LTV ratio as a result of adding the cost of said taxes, insurance, HOA, and/or other housing related costs to the amount of said financial product, thereby effectively reducing the initial outlays of funds from a home buyer needing a home loan (and/or reducing payments over a period of 3, 5, 7, 10 years; or other time period), wherein the level of indebtedness incurred is increased to support the new asset which is used to pay taxes, insurance and other housing related charge through usage of a computer.

2. The method of claim 1, wherein said financial product is a loan.

3. The method of claim 2, wherein said loan is one of a mortgage loan, a piggy-back loan, and/or a spread account.

4. The method of claim 1, wherein said first and second are mortgage loans.

5. The method of claim 1, wherein said original LTV ratio is the ratio of the amount of said loan to a value of an associated property.

6. The method of claim 5, wherein said value in said original LTV ratio and in said gross LTV ratio is the least of a sales price, appraisal, and broker price opinion.

7. The method of claim 1, wherein the cost of said gross loan establishes a new asset which reduces out of pocket cash costs associated with owning the home through the first five or ten years (and/or other time period) by providing the asset to pay for said costs.

8. The method of claim 7, wherein the amount of the reduction of out of pocket cash costs is further based on at least one of the type of said loan, the time length of said loan, a loan lender, a mortgage guaranty insurer, and/or credit of a borrower.

9. The method of claim 8, wherein said type of said loan is one of a fixed rate mortgage or an adjustable rate mortgage.

10. A method for reducing mortgage costs (cash out of pocket) associated with a loan, the method comprising the steps of: determining an original loan-to-value (LTV) ratio of a loan, wherein said loan is one of a mortgage loan and an interest rate associated therewith, and wherein said original LTV ratio is the ratio of the amount of said loan to a value of an associated property, wherein said loan necessitates a purchase of an asset when said original LTV ratio exceeds a first predetermined level, and wherein a first lien would be charged for said mortgage loan if said mortgage loan were based on said original LTV ratio; adding a cost of at least one basis point to the amount of said loan, wherein said interest rate of said financial product is increased (or decreased) as a result of the added cost of the at least one discount point; achieving a gross LTV ratio of said loan, which is the ratio of the added cost of said basis point(s) and the amount of said loan to said value of said associated property, as a result of adding said cost to the amount of said loan, wherein, when said gross LTV ratio exceeds at least a second predetermined level above said original LTV ratio by the added cost of the at least one basis point as a result of the added cost of said loan, the first mortgage loan charged would be increased to create a new asset and corresponding to said gross LTV ratio if said gross LTV ratio were used to determine mortgage cost increase that should be charged for said mortgage; and offering said mortgage loan for the first mortgage based on said gross LTV ratio, wherein the first mortgage at which said mortgage is offered is determined through usage of a computer.

11. The method of claim 10, wherein the cost of each basis point equals one one hundredth of one percent of the amount of said loan.

12. The method of claim 11, wherein each said basis point creates an increasingly valuable asset as the LTV is increased.

13. The method of claim 12, wherein said type of said loan is one of a fixed rate mortgage or an adjustable rate mortgage.

14. The method of claim 10, wherein said increase in LTV and mortgage loan creates a new asset of any type.

15. The method of claim 14, wherein said basis points are determined based on at least one of said original LTV ratio, a debt-to-income ratio of a borrower, and/or the credit of said borrower.

16. The method of claim 10, wherein said value in said original LTV ratio is the least of a sales price, appraisal, and broker price opinion; and said gross LTV is the increased mortgage loan size that creates said asset.
